(19) United States
(12) Patent Application Publication
(10) Pub. No.: US 2015/0085631 A1
(43) Pub. Date: Mar. 26, 2015

(54) TRACKING CONTROL METHOD, TRACKING CONTROL DEVICE, AND OPTICAL DISC DEVICE

(71) Applicant: Mitsubishi Electric Corporation, Tokyo (JP)

(72) Inventors: Yusuke Kanatake, Tokyo (JP); Nobuo Takeshita, Tokyo (JP)

(73) Assignee: Mitsubishi Electric Corporation, Tokyo (JP)

(21) Appl. No.: 14/387,878

(22) PCT Filed: Dec. 18, 2012
(86) PCT No.: PCT/JP2012/082723

§ 371 Date: Sep. 25, 2014

(30) Foreign Application Priority Data
Apr. 18, 2012 (JP) 2012-094326

(51) Int. Cl. G11B 7/1392

(52) U.S. Cl. CPC G11B 7/13927
USPC 369/47.49

(57) ABSTRACT

A tracking control method relates to an optical pickup 11 including an object lens 11a for focusing laser light on an information recording surface of an optical disc 40, and a light receiving element 11b that receives reflected light from the information recording surface of the optical disc 40 and converts the light to an electric signal. The tracking control method includes a lens middle point control step (S4) of controlling a position of the object lens 11a so as to suppress vibration of the object lens 11a based on a signal obtained by feedback of a lens error signal generated from the electric signal, a tracking pull-in step (S9) of performing tracking pull-in processing to control a position of the object lens 11a to follow a track of the optical disc 40, and a step (S7) of lowering a loop gain of the feedback of a lens middle point control in the lens middle point control step before the tracking pull-in step is started.

### TECHNICAL FIELD

The present invention relates to an optical disc device, and particularly relates to a tracking control method and a tracking control device.

### BACKGROUND ART

Recently, optical disc devices compatible with optical discs such as a BD (Blu-ray Disc), a DVD (Digital Versatile Disc), and a CD (Compact Disc) have been broadly used. In the optical disc device, a surface deflection (i.e., a vibration in a focusing direction) and an eccentricity (i.e., a vibration in a tracking direction) may occur during a rotation of the optical disc. The surface deflection and eccentricity are in the form of sine waves having a period corresponding to a time required for one rotation of the optical disc, and having amplitudes respectively corresponding to a surface deflection amount and an amount of eccentricity. A tracking control is performed so as to make an object lens follow the eccentricity of the optical disc as follows.

Generally, a tracking pull-in (i.e., a transfer to the tracking control) is performed after a speed at which the object lens crosses a track (i.e., a track crossing speed) becomes smaller than a predetermined value. A limit value of the track crossing speed varies depending on a configuration of the optical disc device and a kind of the optical disc (i.e., BD/DVD/CD or read-only/write-once/rewritable type), but is usually close to zero. Therefore, the tracking pull-in is generally performed after the track crossing speed becomes almost zero.

For example, in a technology disclosed in Patent Document 1, a rotation angle at which a displacement amount of the optical disc due to eccentricity becomes the maximum is learned, and the amount of eccentricity of the optical disc is detected. The tracking pull-in is performed at the rotation angle at which the displacement amount of the optical disc due to eccentricity becomes the maximum, and the object lens is moved by an amount corresponding to the detected amount of eccentricity.

In a technology disclosed in Patent Document 2, a position at which the eccentricity becomes the minimum is detected during a rotation of the optical disc. The tracking pull-in is performed at the position at which the eccentricity becomes the minimum.

In this regard, the tracking pull-in need be performed in a state where an influence of vibration of the object lens is eliminated. Therefore, before the tracking pull-in is performed, it is desirable to detect a lens error signal corresponding to displacement of the object lens, and to perform a control for maintaining the object lens at a predetermined neutral position (hereinafter referred to as a lens middle point control) by feeding back the lens error signal.

For example, in a technology disclosed in Patent Document 3, the maximum or minimum value of the lens displacement is detected based on the lens error signal for each rotation phase of the optical disc, and is stored. After the lens middle point control is performed, the tracking pull-in is performed at the rotation angle at which the displacement of the optical disc due to eccentricity becomes the maximum.

### PRIOR ART DOCUMENT

### Patent Document

[Patent Document 1] Japanese Laid-Open Patent Publication 2008-299963 (see, Abstract)
[Patent Document 2] Japanese Laid-Open Patent Publication 2004-062992 (see, Abstract)
[Patent Document 3] Japanese Laid-Open Patent Publication 2008-269662 (see, Abstract)

### SUMMARY OF THE INVENTION

### Problems to be Solved by the Invention

However, the optical disc may not only have a recording region, but may also have a non-recording region (a region where information is not recorded). The recording region and the non-recording region are different from each other in light reflection condition, and therefore the lens error signal becomes discontinuous at a boundary between both regions. Therefore, if the lens middle point control is performed straddling the recording region and the non-recording region of the optical disc (i.e., if the object lens, passes through the boundary between the recording region and the non-recording region), the object lens is overcontrolled at a point where the lens error signal becomes discontinuous. Therefore, the vibration of the object lens increases, and there is a possibility that the tracking pull-in may not be stably performed. In this case, the tracking pull-in may not only take time, but may also be unsuccessful. Therefore, recording and reproduction of information may not be possible.

For example, the technology disclosed in Patent Document 3 is based on a premise that a rotation phase of the optical disc where the displacement of the optical disc due to eccentricity becomes the maximum or minimum is the same as a rotation phase of the optical disc where the track crossing speed is almost zero. In order to establish the premise, it is necessary to suppress the vibration of the optical disc. In other words, it is necessary to perform the lens middle point control before the tracking pull-in.

However, if the lens middle point control is performed straddling the recording region and the non-recording region of the optical disc, the object lens is overcontrolled as described above, and the vibration of the object lens increases. As a result, the above-described premise may not be established, and the tracking pull-in may be performed at the rotation phase where the track crossing speed is not zero. Therefore, the tracking pull-in may be unsuccessful.

The present invention is intended to solve the above described problems, and an object of the present invention is to enable performing a tracking pull-in more stably.

### Means for Solving the Problems

A tracking control method according to the present invention is a tracking control method for an optical pickup including an object lens for focusing laser light on an information recording surface of an optical disc, and a light receiving element that receives reflected light from the information recording surface of the optical disc and converts the light to an electric signal. The tracking control method includes a lens middle point control step of controlling a position of the object lens so as to suppress vibration of the object lens based on a signal obtained by feedback of a lens error signal generated from the electric signal, a tracking pull-in step of performing tracking pull-in processing to control a position of the object lens to follow a track of the optical disc, and a step of lowering a loop gain of the feedback of a lens middle point control in the lens middle point control step before the tracking pull-in step is started.

A tracking control device according to the present invention is a tracking control device performing a tracking control for an optical pickup including an object lens for focusing laser light on an information recording surface of an optical disc, and a light receiving element that receives reflected light from the information recording surface of the optical disc and converts the light to an electric signal. The tracking control device includes a lens middle point control unit that controls a position of the object lens so as to suppress vibration of the object lens based on a signal obtained by feedback of a lens error signal generated from the electric signal, a tracking pull-in unit that performs tracking pull-in processing to control a position of the object lens to follow a track of the optical disc, and a loop gain control unit that lowers a loop gain of the feedback of a lens middle point control by the lens middle point control unit before the tracking pull-in unit starts the tracking pull-in processing.

The optical disc device according to the present invention includes the above described tracking control device.

### Effect of the Invention

According to the present invention, the loop gain of the feedback of the lens middle point control is lowered before the tracking pull-in is started, and therefore a stable tracking pull-in is achieved.

### BRIEF DESCRIPTION OF THE DRAWINGS

FIG. 1 is a block diagram showing a basic configuration of an optical disc device including a tracking control device according to Embodiment 1 of the present invention.

FIG. 2 is a diagram showing respective signal waveforms when a lens middle point control and a tracking pull-in are performed using technology disclosed in Patent Document 3.

FIG. 3 is a diagram showing respective signal waveforms when a lens middle point control and a tracking pull-in are performed according to Embodiment 1 of the present invention.

FIG. 4 is a flowchart showing a tracking control method performed by the tracking control device according to Embodiment 1 of the present invention.

FIG. 5 is a block diagram showing a basic configuration of an optical disc device including a tracking control device according to Embodiment 2 of the present invention.

FIG. 6 is a flowchart showing a tracking control method by the tracking control device according to Embodiment 2 of the present invention.

### EMBODIMENT FOR CARRYING OUT THE INVENTION

### Embodiment 1

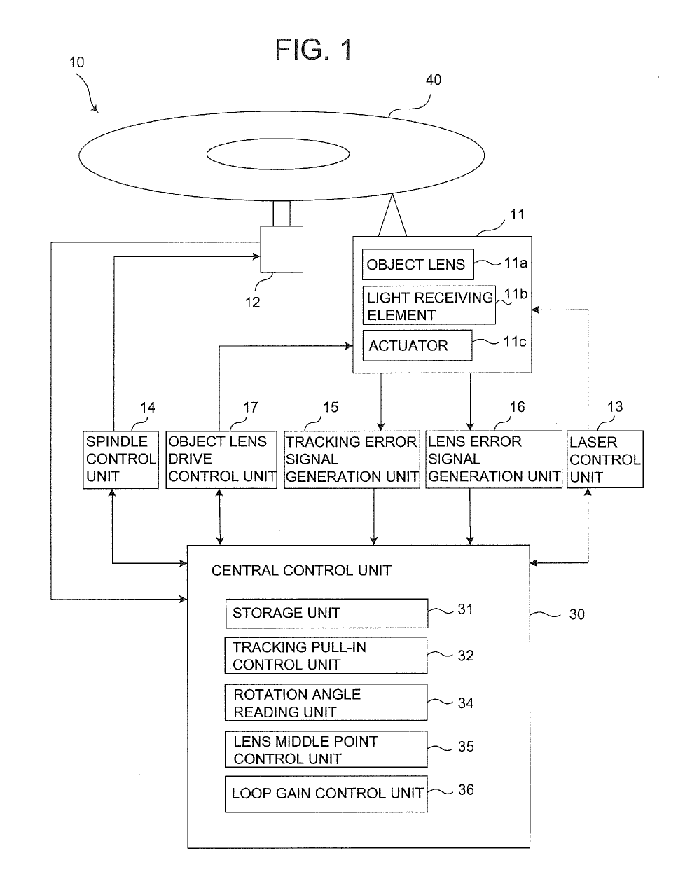

FIG. 1 is a block diagram showing a basic configuration of an optical disc device 10 including a tracking control device according to Embodiment 1 of the present invention (i.e., a device capable of performing a tracking control method according to Embodiment 1 of the present invention). The optical disc device 10 is a device that performs recording and/or reproducing using an optical disc 40. The optical disc 40 is, for example, a BD, DVD or CD. The BD, DVD and CD may respectively include discs classified into a read-only type, a write-once type and a rewritable type.

As shown in FIG. 1, the optical disc device 10 includes an optical pickup 11, a spindle motor 12, a laser control unit 13, a spindle control unit 14, a tracking error signal generation unit 15, a lens error signal generation unit 16, an object lens drive control unit 17, and a central control unit 30.

The central control unit 30 performs at least a tracking control in the optical disc device 10. The central control unit 30 may be constituted by, for example, a computer having a CPU (Central Processing Unit). Further, the central control unit 30 includes a storage unit 31 such as a memory that stores various kinds of data and programs required for the tracking control. In this regard, the central control unit 30 may be configured to entirely control the optical disc device 10.

The optical pickup 11 includes main optical components for recording information on or reproducing information from the optical disc 40. To be more specific, the optical pickup 11 includes an object lens 11a and a light receiving element 11b.

The object lens 11a focuses laser emitted by a laser emission unit of the laser control unit 13 described later on an information recording surface of the optical disc 40. The light receiving element 11b receives reflected light from the information recording surface of the optical disc 40 irradiated with the laser light. The light receiving element 11b converts a received light signal into an electric signal, and outputs the electric signal.

The optical pickup 11 further includes an actuator 11c that drives the object lens 11a in a radial direction of the optical disc (i.e., a tracking direction), and in a direction perpendicular to the information recording surface of the optical disc (i.e., a focusing direction). The actuator 11c includes, for example, electromagnetic coils fixed to a lens holder that holds the object lens 11a, magnets provided so as to face the electromagnetic coils, and the like.

The spindle motor 12 is controlled by the spindle control unit 14, and rotates the optical disc 40. Further, the spindle motor 12 outputs a rotation angle of the optical disc 40 to the central control unit 30.

The spindle control unit (i.e., a rotation control unit) 14 controls a rotation of the spindle motor 12. Information on the number of rotations and a rotation method according to a kind of the optical disc stored in the storage unit 31 of the central control unit 30 is inputted into the spindle control unit 14. The spindle control unit 14 controls the rotation of the spindle motor 12 based on the inputted information so as to rotate the optical disc 40.

In this regard, the number of rotations and the rotation method of the spindle motor 12 differ depending on the kind of optical disc 40. For example, the rotation method is mainly divided into CAV (Constant Angular Velocity) in which an angular velocity is constant, and CLV (Constant Linear Velocity) in which a linear velocity is constant.

The laser control unit 13 has a laser emission unit that emits laser light to irradiate the information recording surface of the optical disc 40 via the object lens 11a. A laser power value according to the kind of the optical disc stored in the storage unit 31 of the central control unit 30 is inputted into the laser control unit 13. The laser control unit 13 emits laser light based on the inputted laser power value.

The tracking error signal generation unit 15 generates a tracking error signal based on the electric signal converted by the light receiving element 11b of the optical pickup 11. The “tracking error signal” is a signal detected when the object lens 11a of the optical pickup 11 crosses a track of the optical disc 40. As a method for generating the tracking error signal by the tracking error signal generation unit 15, conventional methods may be used. The conventional methods are, for example, a push-pull method, a DPP (Differential Push-Pull) method, and a DPD (Differential Phase Detection) method.

The lens error signal generation unit 16 generates a lens error signal corresponding to a position of the object lens 11a of the optical pickup 11 based on the electric signal converted by the light receiving element 11b of the optical pickup 11. For example, as a method for generating the lens error signal, a method disclosed in Patent Document 3 (Japanese Laid-Open Patent Publication No. 2008-269662) may be used. However, the method for generating the lens error signal is not limited thereto.

The object lens drive control unit 17 controls the position of the object lens 11a of the optical pickup 11. To be more specific, the object lens drive control unit 17 controls driving of the object lens actuator 11c of the optical pickup 11 to move the object lens 11a in the tracking direction (i.e., the radial direction of the optical disc 40) so that the object lens 11a follows the track of the optical disc 40. The object lens drive control unit 17 also performs a control to move the object lens 11a in the focusing direction so that the object lens 11a follows a surface deflection of the information recording surface of the optical disc 40.

The storage unit 31 of the central control unit 30 stores the laser power values of the optical pickup 11, the numbers of rotations and the rotation methods of the spindle motor 12 for respective kinds of optical discs 40. Based on the kind of the optical disc to be used, the central control unit 30 selects the laser power value of the optical pickup 11, the number of rotations and the rotation method of the spindle motor 12 from the storage unit 31, and outputs the selected values to the laser control unit 13 and the spindle control unit 14.

The central control unit 30 further includes a tracking pull-in unit 32, a rotation angle reading unit 34, a lens middle point control unit 35, and a loop gain control unit 36. These components may be realized by, for example, hardware such as electronic circuits, or software such as programs mounted to the computer.

The tracking pull-in unit 32 outputs a tracking control signal to the object lens drive control unit 17. The “tracking control signal” is a feedback signal generated based on the tracking error signal generated by the tracking error signal generation unit 15. The object lens drive control unit 17 performs a control to move the object lens 11a in the tracking direction based on the inputted tracking control signal so that the object lens 11a follows eccentricity of the optical disc 40.

The rotation angle reading unit 34 continuously reads a rotation angle of the optical disc 40 based on information on the rotation angle of the optical disc 40 outputted from the spindle motor 12.

The lens middle point control unit 35 adds a feedback signal, which is generated based on the lens error signal generated by the lens error signal generation unit 16, to the tracking control signal. The lens middle point control unit 35 outputs a signal obtained by the addition to the object lens drive control unit 17. The object lens drive control unit 17 drives the object lens 11a in the tracking direction based on the inputted signal so as to suppress the vibration of the object lens 11a. This lens middle point control is performed prior to the tracking pull-in.

The loop gain control unit 36 performs processing to lower (i.e., decrease) a loop gain during the lens middle point control. The tracking pull-in is preferably performed in a state where the vibration of the object lens 11a is suppressed by the lens middle point control. A vibration suppression ability for the object lens 11a is determined by the loop gain of feedback of the lens middle point control. That is, it becomes easy to suppress the vibration of the object lens 11a, as the loop gain increases (i.e., as a responsiveness becomes higher). In contrast, a lens error becomes discontinuous at a boundary between a recording region and a non-recording region of the optical disc as described later, and therefore oscillation of feedback loop is of particular concern. Therefore, in this embodiment, the loop gain is lowered (that is, the responsiveness is lowered) during the lens middle point control to thereby certainly eliminate the influence of vibration of the object lens 11a, and the tracking pull-in is performed in this state.

In this regard, the central control unit 30 shown in FIG. 1 corresponds to a tracking control device in this embodiment. However, the tracking control device is not limited to the configuration shown in FIG. 1.

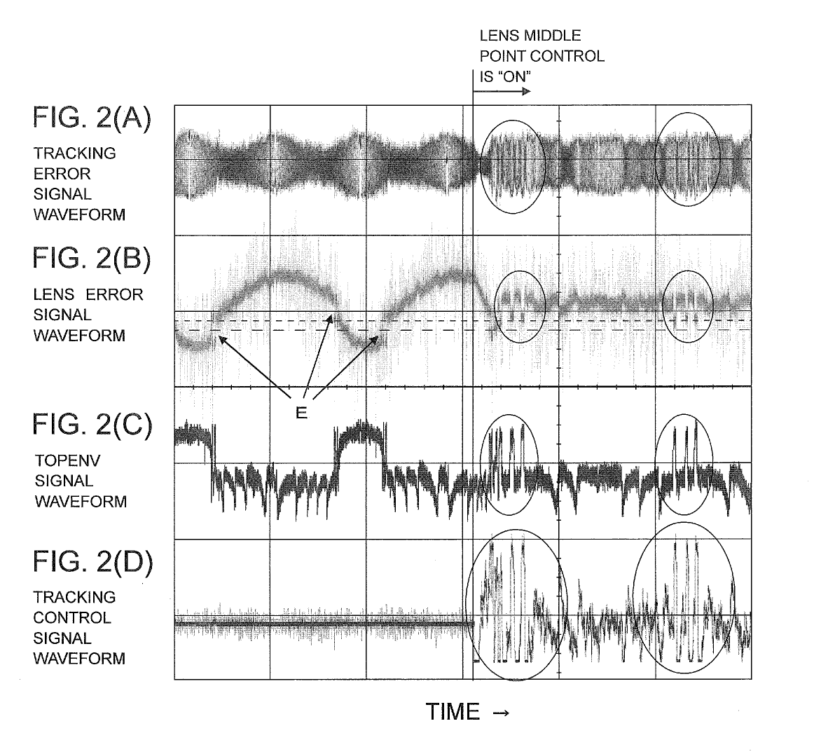

FIG. 2 shows respective signal waveforms when the lens middle point control and the tracking pull-in are performed using technology disclosed in Patent Document 3. FIG. 2 shows waveforms of predetermined periods before and after a start (ON) of the lens middle point control. FIG. 2 does not belong to this embodiment, but will be described using the same marks as the components of this embodiment for convenience.

FIG. 2(A) shows a tracking error signal waveform. FIG. 2(B) shows a lens error signal waveform. FIG. 2(C) shows a top envelope waveform of a reproduction signal (hereinafter, referred to as TOPENV). FIG. 2(D) shows a tracking control signal waveform.

The tracking error signal waveform shown in FIG. 2(A) is generated by the tracking error signal generation unit 15 using the push-pull method, the DPP method or the like.

The lens error signal waveform shown in FIG. 2(B) is generated by the lens error signal generation unit 16. An undulation of the lens error signal waveform prior to the lens middle point control represents a vibrational component of the object lens 11a.

The TOPENV waveform shown in FIG. 2(C) is a top envelope waveform of the reproduction signal generated based on the electric signal outputted from the light receiving element 11b of the optical pickup 11. A level of the TOPENV waveform changes between the recording region and the non-recording region of the optical disc.

The tracking control signal waveform shown in FIG. 2(D) is a waveform of a drive control signal outputted by the object lens drive control unit 17 to the object lens 11a of the optical pickup 11. During the tracking pull-in control, the tracking control signal waveform is generated by feedback of the tracking error signal waveform of FIG. 2(A). During the lens middle point control, the tracking control signal waveform is generated by feedback of the lens error signal waveform of FIG. 2(B).

As shown in FIG. 2(B), at the boundary between the recording region and the non-recording region of the optical disc 40, the lens error signal becomes discontinuous (as shown by mark E in FIG. 2(B)). If the lens middle point control is performed based on such discontinuous lens error signal, an overcontrol of tracking occurs as shown by a circle in FIG. 2, and the lens error signal waveform is disturbed. This means that vibration of the object lens 11a increases when the lens middle point control is performed straddling the recording region and the non-recording region. For this reason, the tracking error signal waveform (FIG. 2(A)) becomes irregular.

In a state where the tracking is OFF, the tracking error signal waveform is a regular waveform in which sparse portions (i.e., portions with a long waveform period) and dense portions (i.e., portions with a short waveform period) are repeated in a direction of time. However, the tracking error signal waveform shown in FIG. 2(A) contains a lot of sparse portions. In the technology disclosed in Patent Document 3, the tracking pull-in is performed when displacement of the optical disc 40 due to eccentricity becomes the maximum. However, if the lens middle point control is performed straddling the recording region and the non-recording region of the optical disc 40 as shown in FIG. 2, the tracking pull-in may not be performed at a desired timing, and there is a possibility that the tracking pull-in may fail.

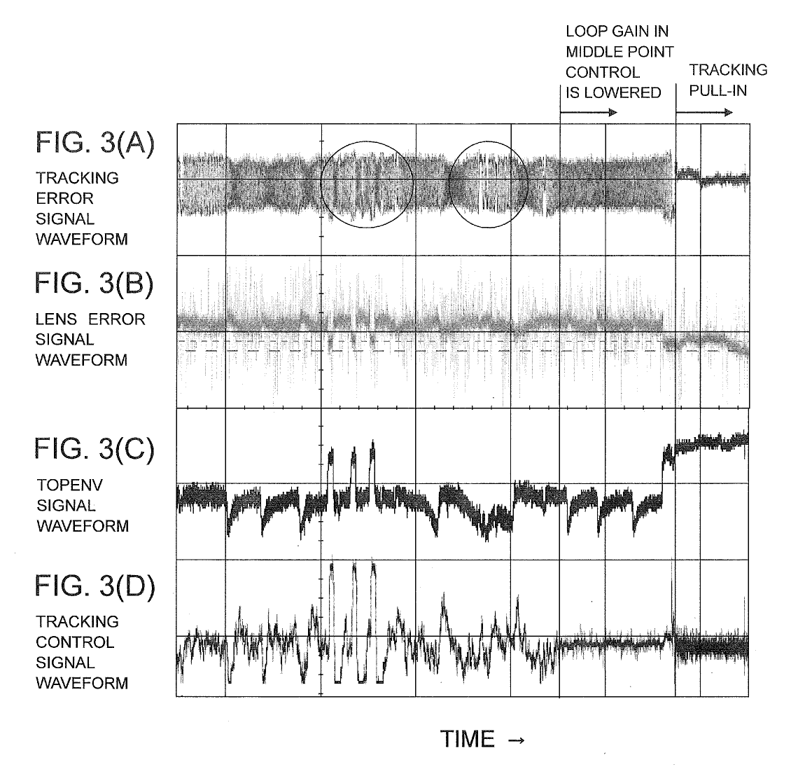

FIG. 3 shows respective signal waveforms when the lens middle point control and the tracking pull-in according to this embodiment are performed. FIG. 3(A) shows the tracking error signal waveform. FIG. 3(B) shows the lens error signal waveform. FIG. 3(C) shows the TOPENV waveform of the reproduction signal. FIG. 3(D) shows the tracking control signal waveform. In this regard, in FIG. 3, the lens middle point control has already been started at time 0 (i.e., left end).

As shown in FIG. 3, in this embodiment, the loop gain of the feedback of the lens middle point control is lowered during the lens middle point control (i.e., before performing the tracking pull-in). When the loop gain is lowered (i.e., when the responsiveness is lowered), the overcontrol of tracking becomes less likely to occur even if the lens middle point control is performed straddling the recording region and the non-recording region of the optical disc 40. Therefore, regularity of the tracking error signal waveform (i.e., relationship between sparse and dense portions) can be maintained.

In this regard, if the loop gain of the feedback of the lens middle point control is lowered from the start, the amount of the vibration of the object lens 11a cannot be suppressed within a predetermined range. Therefore, it becomes difficult to eliminate the influence of the vibration of the object lens 11a when performing the tracking pull-in.

Therefore, in this embodiment, the loop gain of the feedback of the lens middle point control is lowered from halfway. With such an arrangement, it becomes possible to perform the tracking pull-in before the object lens starts vibrating, and to prevent the overcontrol of tracking to thereby maintain the regularity of the tracking error signal waveform (i.e., the relationship between sparse and dense portions).

Here, description will be made of a timing when the loop gain of the feedback of the lens middle point control is lowered, and a lowered value of the loop gain.

The timing when the loop gain of the feedback of the lens middle point control is lowered is a predetermined time prior to a timing when the tracking pull-in is started. The predetermined time can be expressed using arbitrary indexes. For example, if it is assumed that the tracking pull-in is performed when the optical disc 40 reaches a rotation angle at which displacement of the optical disc 40 due to eccentricity becomes the maximum, the loop gain may be lowered when the optical disc 40 reaches a predetermined rotation angle prior to the rotation angle at which the displacement of the optical disc 40 becomes the maximum. It is also possible to preliminarily determine a rotation angle after the loop gain of the feedback of the lens middle point control is lowered and before the object lens 11a starts vibrating. In this case, the loop gain is lowered when the optical disc 40 reaches the preliminarily determined rotation angle prior to the rotation angle of the optical disc 40 at which the tracking pull-in is started.

Moreover, the lowered value of the loop gain of the feedback of the lens middle point control need only be in a range in which the regularity of the tracking error signal (i.e., the relationship between sparse and dense portions) is maintained. For example, it is possible to determine the value of the loop gain with which the regularity of the tracking error signal is maintained, by performing experiments while varying the value of the loop gain and observing what kind of tracking signal is generated. It is also possible that the gain value is zero.

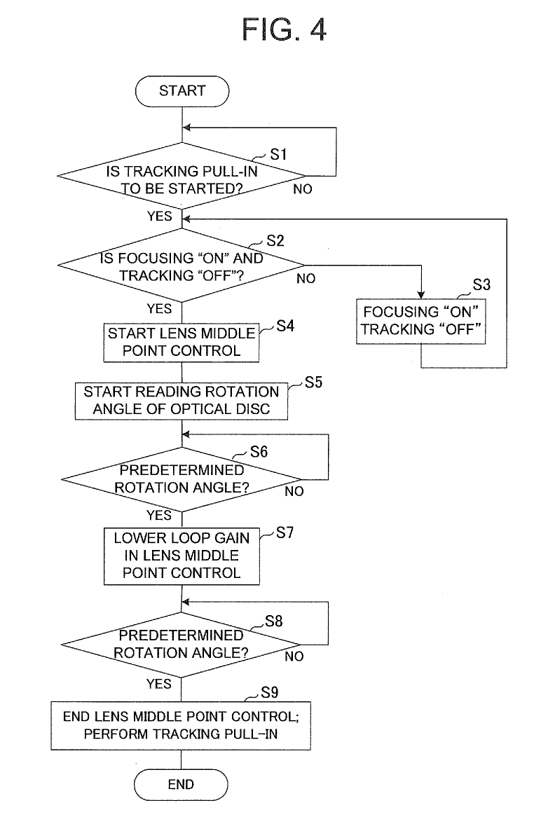

Next, a tracking control method according to this embodiment, i.e., a tracking control performed by the tracking control device will be described with reference to FIG. 4.

FIG. 4 is a flowchart showing an example of the tracking control performed by the tracking control device according to this embodiment. Here, this flowchart is performed by the central control unit 30 according to the program stored in the storage unit 31.

When the tracking control is started, first, whether the tracking pull-in processing is to be started or not is judged (step S1). If the tracking pull-in processing is to be started (YES in step S1), the control proceeds to next step S2. If the tracking pull-in processing is not to be started (NO in step S1), judgment in step S1 is repeated. The judgment in step S1 is performed by, for example, the central control unit 30. The central control unit 30 stores a result of the judgment in the storage unit 31.

Next, judgment whether the focusing control is ON and the tracking control is OFF is performed (step S2). To be more specific, for example, if an amplitude value of the tracking error signal generated by the tracking error signal generation unit 15 exceeds a certain threshold value, it is judged that the tracking control is OFF. In contrast, if the amplitude value of the tracking error signal does not exceed the threshold value, it is judged that the tracking control is ON. The judgment in step S2 is performed by, for example, the central control unit 30. The central control unit 30 stores a result of the judgment in the storage unit 31. In this regard, a judgment method and judgment means in step S2 are not limited to the above described example.

In step S2, if it is judged that the focusing is ON and the tracking is OFF (YES in step S2), the control proceeds to step S4. Otherwise (NO in step S2), the control proceeds to step S3.

In step S3, the focusing control is turned ON and the tracking control is turned OFF. That is, if the focusing control is OFF in the above described step S2, the focusing control is turned ON. If the tracking control is ON in the above described step S2, the tracking control is turned OFF. Processing in step S3 is performed by, for example, the central control unit 30. In this case, the object lens drive control unit 17 moves the object lens 11a in the focusing direction based on a focusing control signal (obtained by feedback of a focusing error signal) outputted by the central control unit 30. As to the tracking direction, the object lens drive control unit 17 moves the object lens 11a based on the addition signal outputted by the lens middle point control unit 35 in the lens middle point control (step S4) described later.

In this regard, the reason why the focusing control is turned ON in step S3 is because neither the lens error signal nor the tracking error signal is generated in a state where the laser light is not focused on the information recording surface of the optical disc 40. Therefore, the lens middle point control and the tracking pull-in control are performed in a state where the focusing control is ON and in a state where the laser light is focused on the information recording surface of the optical disc 40.

After step S3 is completed, the control returns to step S2 again. The judgment whether the focusing control is ON and the tracking control is OFF is performed. Processing of step S2 and processing of step S3 are repeated until the judgment in step S2 becomes YES.

Next, the lens middle point control is started (step S4). The lens middle point control is a control for suppressing the vibration of the object lens 11a and performed by the object lens drive control unit 17. The loop gain of the feedback of this lens middle point control is preferably determined so that a vibration amount of the object lens 11a is within a predetermined range.

Step S4 is performed by, for example, the lens middle point control unit 35 and the loop gain control unit 36 of the central control unit 30. The lens middle point control unit 35 sends instruction to the object lens drive control unit 17 so as to perform the lens middle point control. That is, the lens middle point control unit 35 adds the feedback signal generated based on the lens error signal generated by the lens error signal generation unit 16 to the tracking control signal, and outputs the addition signal to the object lens drive control unit 17. The object lens drive control unit 17 drives the object lens 11a in the tracking direction based on the inputted signal.

Next, reading of the rotation angle of the optical disc 40 is performed (step S5). The reading of the rotation angle of the optical disc 40 is performed by, for example, the rotation angle reading unit 34 of the central control unit 30. Information on the rotation angle of the optical disc 40 is outputted by the spindle motor 12, and is inputted into the rotation angle reading unit 34.

Further, after the reading of the rotation angle of the optical disc 40 is started in step S5, the rotation angle reading unit 34 continuously reads the rotation angle of the optical disc 40, and stores the rotation angle in the storage unit 31 of the central control unit 30.

The rotation angle of the optical disc 40 closely relates to an eccentricity phase angle of the optical disc 40, and relationship therebetween depends on a chucking state of the optical disc 40. The chucking state is a state where the optical disc 40 is held between a turntable mounted to the spindle motor 12 and a clamper facing the turntable. As long as the chucking state is the same, the relationship between the rotation angle and the eccentricity phase angle of the optical disc 40 is the same. Once the optical disc 40 is ejected, the relationship ends. The relationship between the rotation angle and the eccentricity phase angle of the optical disc 40 may be determined at any timing and using any method after the optical disc 40 is inserted.

In this regard, the relationship between the rotation angle and the eccentricity phase angle of the optical disc 40 is preliminarily determined before the tracking control of FIG. 4 is started. This is for determining the timing to perform the tracking pull-in in step S9 described later. The tracking pull-in is performed at the timing when the displacement of the optical disc 40 due to eccentricity becomes the maximum. In the case where an eccentricity component is approximated by a sine wave, the timing when the displacement of the optical disc 40 due to eccentricity becomes the maximum is a timing when the eccentricity phase angle is 90 degrees or 270 degrees. Therefore, the relationship between the rotation angle and the eccentricity phase angle of the optical disc 40 is preliminarily determined, and the tracking pull-in is performed when the rotation angle of the optical disc 40 becomes a rotation angle corresponding to the eccentricity phase angle (i.e., 90 degrees or 270 degrees) at which the displacement of the optical disc due to eccentricity becomes the maximum.

Next, judgment whether the rotation angle of the optical disc 40 read in the above described step S5 reaches the predetermined rotation angle at which processing to lower the loop gain is to be performed (step S6). Step S6 is performed by, for example, the central control unit 30. Here, the predetermined rotation angle is set to, for example, a predetermined rotation angle prior to the rotation angle at which the tracking pull-in (step S9) is performed.

If the rotation angle of the optical disc 40 reaches the predetermined rotation angle (YES in step S6), the control proceeds to next step S7. If the rotation angle of the optical disc 40 does not reach the predetermined rotation angle (No in step S6), the processing of step S6 and the processing of S7 are repeated until the predetermined rotation angle is reached. In this regard, after the rotation angle reading unit 34 of the central control unit 30 starts reading the rotation angle of the optical disc 40 in the above described step S5, the rotation angle reading unit 34 continuously reads the rotation angle of the optical disc 40, and stores the rotation angle in the storage unit 31 of the central control unit 30.

If the judgment in the above described step S6 is YES, the processing to lower the loop gain of the feedback of the lens middle point control is performed (step S7). The gain value when the loop gain is lowered need only be in a range where the sparse and dense portions of the tracking error signal are regularly outputted. For example, the gain value may be determined by preliminarily observing the tracking error signal waveform, or may be set to zero. Step S7 is performed by, for example, the loop gain control unit 36 of the central control unit 30. The loop gain control unit 36 sends instruction to the object lens drive control unit 17 so as to lower the loop gain. Therefore, the object lens drive control unit 17 lowers the loop gain, and controls driving of the object lens 11a.

Next, judgment whether the rotation angle of the optical disc 40 reaches the rotation angle at which the tracking pull-in is to be started is performed (step S8). As described in relation to step S9, the tracking pull-in is performed when the rotation angle of the optical disc 40 becomes the rotation angle corresponding to the eccentricity phase angle (i.e., 90 degrees or 270 degrees) at which the displacement of the optical disc becomes the maximum.

If the rotation angle of the optical disc 40 reaches the predetermined rotation angle (YES in step S8), the control proceeds to next step S9. If the rotation angle of the optical disc 40 does not reach the predetermined rotation angle (NO in step S8), steps S8 and S9 are repeated until the predetermined rotation angle is reached. Step S8 is performed by, for example, the central control unit 30.

Then, the lens middle point control is terminated, and the tracking pull-in is performed (step S9). That is, the object lens 11a is controlled to follow the eccentricity of the optical disc 40. Step S9 is performed by, for example, the tracking pull-in unit 32 of the central control unit 30. That is, the tracking pull-in unit 32 outputs the tracking control signal obtained by feedback of the tracking error signal generated by the tracking error signal generation unit 15 to the object lens drive control unit 17. The object lens drive control unit 17 moves the object lens 11a in the tracking direction based on the tracking control signal so that the object lens 11a follows the track of the optical disc 40. In this regard, it is desirable that the tracking pull-in is performed at the same as the termination of the lens middle point control.

When the processing of step 9 is completed, the tracking control shown in FIG. 4 is terminated.

As described above, according to the tracking control method, the tracking control device and the disc device of Embodiment 1 of the present invention, the lens middle point control is performed, and the loop gain of the lens middle point control is lowered before the tracking pull-in is performed.

Therefore, it becomes possible to prevent the overcontrol of tracking caused by straddling the recording region and the non-recording region. Therefore, the vibration of the object lens 11a can be certainly suppressed, and the stable tracking pull-in can be achieved.

### Embodiment 2

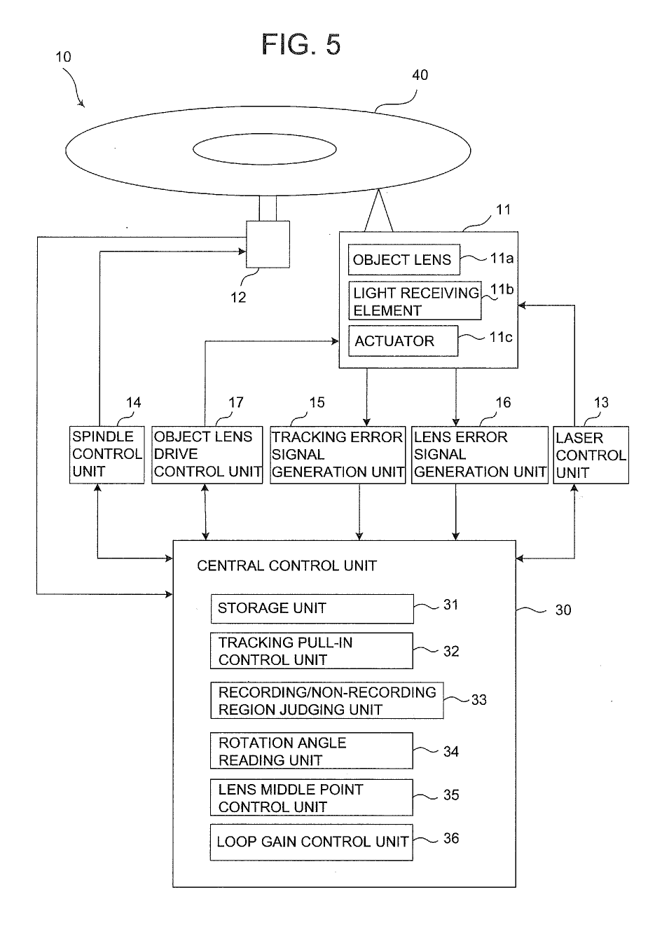

FIG. 5 is a block diagram showing a basic configuration of an optical disc device 10 including a tracking control device according to Embodiment 2 of the present invention. In the tracking control device according to Embodiment 2, a recording/non-recording region judgment unit 33 for judging a recording region and a non-recording region is added to the tracking control device (FIG. 1) described in Embodiment 1. Other components are the same as those of the tracking control device of Embodiment 1.

In Embodiment 2, signals for judging the recording region and the non-recording region of the optical disc 40 are detected. The loop gain of the feedback of the lens middle point control is lowered only when the recording region and the non-recording region are straddled (i.e., when the object lens 11a passes through the boundary between the recording region and the non-recording region of the optical disc 40) during the lens middle point control. In this case, there is an advantage that, if the recording region and the non-recording region are not straddled during the lens middle point control, the lens middle point control can be performed without lowering the loop gain.

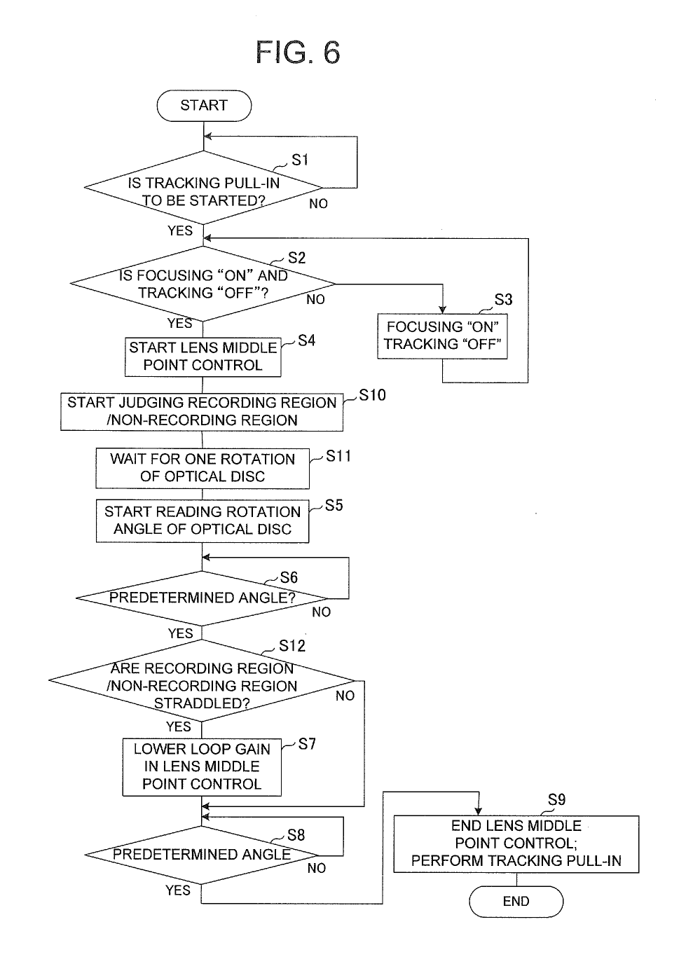

FIG. 6 is a flowchart showing an example of a tracking control performed by the tracking control device according to Embodiment 2. In the flowchart of FIG. 6, steps S10 through S12 are added to the flowchart of FIG. 4. Steps S1 through S9 of FIG. 6 are the same as steps S1 through S9 of FIG. 4, and explanations thereof will be omitted.

In the tracking control shown in FIG. 6, after the lens middle point control is started in step S4, detection of a signal representing the recording region or the non-recording region of the optical disc 40 is started (step S10). This is for judgment whether the recording region and the non-recording region are straddled or not during the lens middle point control in subsequent step S12.

For example, the TOPENV signal may be used as the signal representing the recording region or the non-recording region of the optical disc 40. The judgment in step S10 is performed by, for example, the recording/non-recording region judgment unit 33 of the central control unit 30. The recording/non-recording region judgment unit 33 continuously monitors a level value of the TOPENV signal generated by a not shown reproduction signal generation unit, and stores the level value in the storage unit 31.

Next, waiting for one rotation of the optical disc 40 is performed (step S11). Step S11 is performed by, for example, monitoring the rotation angle of the spindle motor 12 by the central control unit 30.

A reason for waiting for one rotation of the optical disc 40 is as follows. That is, when the tracking control is OFF, the object lens 11a does not follow the eccentricity of the optical disc 40. Therefore, the object lens 11a relatively moves on a trajectory corresponding to the eccentricity of the optical disc 40. This trajectory is a sine wave whose period corresponds to one rotation of the optical disc 40. Therefore, in order to judge whether the boundary between the recording region and the non-recording region is straddled, it is only necessary to wait for one rotation of the optical disc 40. That is, if the boundary is not straddled during at least one rotation of the optical disc 40, it means that the boundary need not be taken into consideration when performing the tracking pull-in.

In following step S6, judgment whether the rotation angle of the optical disc 40 reaches the predetermined rotation angle is performed as described in Embodiment 1, and then judgment whether the recording region and the non-recording region are straddled during the lens middle point control is performed (step S12).

This judgment is based on a change in a level of the above described signal (for example, the TOPENV) representing the recording region and the non-recording region during one rotation of the optical disc 40. This judgment is performed by, for example, the recording/non-recording region judgment unit 33 of the central control unit 30.

As a result of the judgment in step S12, if it is judged that the recording region and the non-recording region are straddled during the lens middle point control (YES in step S12), the loop gain of the lens middle point control is lowered in step S7 as in Embodiment 1, and then the control proceeds to step S8.

In contrast, as a result of the judgment in step S12, if it is judged that the boundary between the recording region and the non-recording region is not straddled during the lens middle point control (NO in step S12), the control proceeds to step S8 without performing the processing of step S7. The processing after the step S8 is the same as that described in Embodiment 1.

As described above, according to the tracking control device and the tracking control method of Embodiment 2 of the present invention, the loop gain is not lowered if the recording region and the non-recording region are not straddled during the lens middle point control. Therefore, in addition to the advantage described in Embodiment 1, the vibration of the object lens 11a can be suppressed more certainly.

The tracking control device and the tracking control method in the respective embodiments may be realized only by hardware resources such as electronic circuits, or may be realized by cooperation of hardware resources and software resources. In the case of the cooperation of hardware resources and software resources, the tracking control device and the tracking control method are realized in such a manner that, for example, a computer program is executed by a computer. To be more specific, the tracking control device and the tracking control method are realized in such a manner that the computer program stored in a recording medium such as a ROM (Read Only Memory) is read out by a main memory unit, and is executed by a CPU. The computer program may be stored in the recording medium such as an optical disc which is readable by the computer, or may be provided via a network such as internet.

The present invention is not limited to the above described respective embodiments, and various modifications may be made without departing from the scope of the present invention.

### EXPLANATION OF MARKS

10 . . . optical disc device, 11 . . . optical pickup, 11a object lens, 11b . . . light receiving unit, 11c . . . actuator, 12 . . . spindle motor, 13 . . . laser control unit, 14 . . . spindle control unit, 15 . . . tracking error signal generation unit, . . . lens error signal generation unit, 17 . . . object lens drive control unit, 30 . . . central control unit, 31 . . . storage unit, 32 . . . tracking pull-in unit, 33 . . . recording/non-recording region judgment unit, 34 . . . rotation angle reading unit, 35 . . . lens middle point control unit, 36 . . . loop gain control unit, 40 . . . optical disc.

1.-13. (canceled)

14. A tracking control method for an optical pickup comprising an object lens for focusing laser light on an information recording surface of an optical disc, and a light receiving element that receives reflected light from the information recording surface of the optical disc and converts the light to an electric signal,
the tracking control method comprising:
a lens middle point control step of controlling a position of the object lens so as to suppress vibration of the object lens based on a signal obtained by feedback of a lens error signal generated from the electric signal;
a tracking pull-in step of performing tracking pull-in processing to control a position of the object lens to follow a track of the optical disc; and
a step of lowering a loop gain of the feedback of a lens middle point control in the lens middle point control step at a predetermined time before the tracking pull-in step is started,
wherein the predetermined time is determined based on a time after the loop gain is lowered and before the object lens starts vibrating.

15. The tracking control method according to claim 14, further comprising:
a rotation angle reading step of reading a rotation angle of the optical disc,
wherein the step of lowering the loop gain is started when the rotation angle read in the rotation angle reading step reaches a predetermined angle prior to the rotation angle at which the tracking pull-in is started.

16. The tracking control method according to claim 15, wherein when the rotation angle of the optical disc read in the rotation angle reading step reaches a predetermined rotation angle at which displacement of the optical disc due to eccentricity is maximum, the lens middle point control step is terminated, and the tracking pull-in step is started.

17. The tracking control method according to claim 15, wherein, in the rotation angle reading step, a rotation angle of the optical disc is read based on an output signal of a spindle motor for rotating the optical disc.

18. The tracking control method according to claim 16, wherein, in the rotation angle reading step, a rotation angle of the optical disc is read based on an output signal of a spindle motor for rotating the optical disc.

19. The tracking control method according to claim 17, further comprising:
a recording/non-recording region judging step of judging whether the object lens passes through a boundary between a recording region and a non-recording region of the optical disc during the lens middle point control step,
wherein the step of lowering the loop gain is performed when it is judged that the object lens passes through the boundary between the recording region and the non-recording region of the optical disc in the recording/non-recording region judging step.

20. The tracking control method according to claim 18, further comprising:
a recording/non-recording region judging step of judging whether the object lens passes through a boundary between a recording region and a non-recording region of the optical disc during the lens middle point control step,
wherein the step of lowering the loop gain is performed when it is judged that the object lens passes through the boundary between the recording region and the non-recording region of the optical disc in the recording/non-recording region judging step.

21. The tracking control method according to claim 19, wherein a gain value preliminarily determined based on a tracking error signal generated from the electric signal is used in the step of lowering the loop gain.

22. The tracking control method according to claim 20, wherein a gain value preliminarily determined based on a tracking error signal generated from the electric signal is used in the step of lowering the loop gain.

23. A tracking control device performing a tracking control for an optical pickup comprising an object lens for focusing laser light on an information recording surface of an optical disc, and a light receiving element that receives reflected light from the information recording surface of the optical disc and converts the light to an electric signal,
the tracking control device comprising:
a lens middle point control unit that controls a position of the object lens so as to suppress vibration of the object lens based on a signal obtained by feedback of a lens error signal generated from the electric signal;
a tracking pull-in unit that performs tracking pull-in processing to control a position of the object lens to follow a track of the optical disc; and
a loop gain control unit that lowers a loop gain of the feedback of a lens middle point control by the lens middle point control unit at a predetermined time before the tracking pull-in unit starts the tracking pull-in processing,
wherein the predetermined time is determined based on a time after the loop gain is lowered and before the object lens starts vibrating.

24. The tracking control device according to claim 23, further comprising:
a rotation angle reading unit that reads a rotation angle of the optical disc,
wherein the loop gain control unit lowers the loop gain when the rotation angle read by the rotation angle reading unit reaches a predetermined angle prior to the rotation angle at which the tracking pull-in is started.

25. The tracking control device according to claim 24, wherein when the rotation angle of the optical disc read by the rotation angle reading unit reaches a predetermined rotation angle at which displacement of the optical disc due to eccentricity is maximum, the lens middle point control by the lens middle point control unit is terminated, and the tracking pull-in processing by the tracking pull-in unit is started.

26. The tracking control device according to claim 24, wherein the rotation angle reading unit reads a rotation angle of the optical disc based on an output signal of a spindle motor for rotating the optical disc.

27. The tracking control device according to claim 25, wherein the rotation angle reading unit reads a rotation angle of the optical disc based on an output signal of a spindle motor for rotating the optical disc.

28. The tracking control device according to claim 26, further comprising:
a recording/non-recording region judging unit that judges whether the object lens passes through a boundary between a recording region and a non-recording region of the optical disc while the lens middle point control unit controls the position of the object lens,
wherein the loop gain control unit lowers the loop gain when the recording/non-recording region judging unit judges that the object lens passes through the boundary between the recording region and the non-recording region of the optical disc.

29. The tracking control device according to claim 27, further comprising:
a recording/non-recording region judging unit that judges whether the object lens passes through a boundary between a recording region and a non-recording region of the optical disc while the lens middle point control unit controls the position of the object lens,
wherein the loop gain control unit lowers the loop gain when the recording/non-recording region judging unit judges that the object lens passes through the boundary between the recording region and the non-recording region of the optical disc.

30. The tracking control device according to claim 28, wherein the loop gain control unit uses a gain value preliminarily determined based on a tracking error signal generated from the electric signal.

31. The tracking control device according to claim 29, wherein the loop gain control unit uses a gain value preliminarily determined based on a tracking error signal generated from the electric signal.

32. An optical disc device comprising the tracking control device according to claim 30.
